(19) United States
(12) Patent Application Publication
(10) Pub. No.: US 2014/0129341 A1
(43) Pub. Date: May 8, 2014

(54) CUSTOMIZABLE APPLICATION FUNCTIONALITY ACTIVITY

(71) Applicant: Abraham Bobrovsky, Rodersdorf (CH)

(72) Inventor: Abraham Bobrovsky, Rodersdorf (CH)

(73) Assignee: EMPIRE TECHNOLOGY DEVELOPMENT LLC, Wilmington, DE (US)

(21) Appl. No.: 13/985,683

(22) PCT Filed: Aug. 27, 2012
(86) PCT No.: PCT/US12/52504

§ 371 Date: Aug. 15, 2013

(51) Int. Cl. G06F 21/36; G06Q 30/02

(52) U.S. Cl. CPC G06F 21/36; G06Q 30/0251; G06Q 30/0267
USPC 705/14.64; 705/14.49; 726/19

(57) ABSTRACT

In one example of customizable application functionality activation, a user interface receives a user's interactive input to a functionality activation sequence field, a security component receives a user's interactive input to the functionality activation sequence field on the user interface to unlock functionality for one or more device features, an integration component receives a customized algorithm for revising at least the appearance of the functionality activation sequence field on the user interface to unlock functionality for the one or more device features, and a functionality implementation component implements a customized functionality activation sequence on the user interface.

### TECHNICAL FIELD

The implementations and embodiments described herein pertain generally to customizable activation of client applications.

### BACKGROUND

Client device manufacturers and distributors have provided users with the ability to customize the appearance of their device graphics, e.g., themes, colors, backgrounds, etc. However, various aspects of device technology have remained under the control of the manufacturers and/or distributors.

### SUMMARY

In one example embodiment, a device comprises a user interface to receive a user's interactive input to a functionality activation sequence field, a security component configured to receive a user's interactive input to the functionality activation sequence field on the user interface to unlock functionality for one or more device features, an integration component configured to receive a customized algorithm for revising at least the appearance of the functionality activation sequence field on the user interface to unlock functionality for the one or more device features, and a functionality implementation component configured to implement a customized functionality activation sequence on the user interface.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which customizable application functionality activation may be implemented, arranged in accordance with at least some embodiments described herein;

FIG. 2 shows an example configuration of a client device having a user interface and client application by which customizable application functionality activation may be implemented, arranged in accordance with at least some embodiments described herein;

FIG. 3 shows an example configuration of a cloud-based service provider for implementing customizable application functionality activation, arranged in accordance with at least some embodiments described herein; and

FIG. 4 shows a block diagram illustrating an example computing device by which various example solutions described herein may be implemented, arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

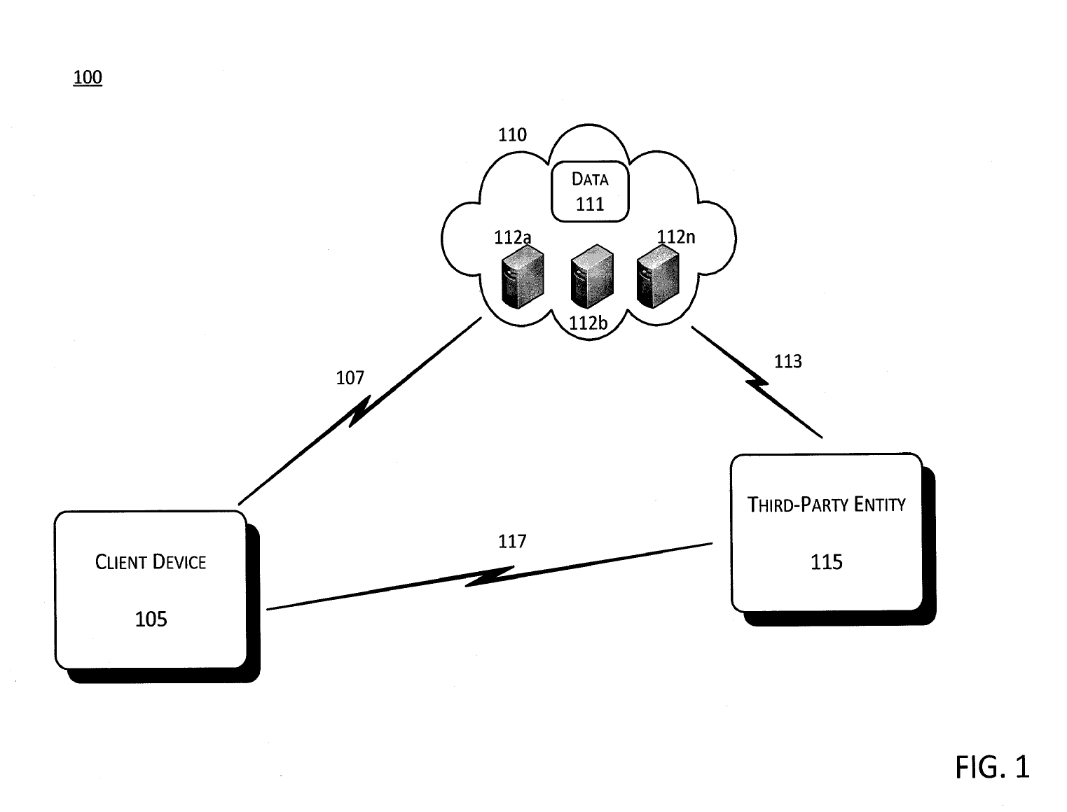

FIG. 1 shows an example system configuration in which customizable application functionality activation may be implemented, arranged in accordance with at least some embodiments described herein. As depicted, configuration 100 may include a client device 105; cloud-based service/data provider 110; and a third-party entity 115 that may be a commercial entity, an advertising entity, and/or some other entity that implements a revenue or product-awareness generating model based at least in-part on advertisements. Further, communication link 107 may refer to a communication link enabled by a protocol utilized to transmit data and/or information between client device 105 and service/data provider 110; communication link 113 may refer to a communication link enabled by a protocol utilized to transmit data and/or information between service/data provider 110 and third-party entity 115; and communication link 117 may refer to a communication link enabled by a protocol utilized to transmit data and/or information between client device 105 and third-party entity 115.

Client device 105 may refer to a processor-based electronic device on which an instance of customizable application functionality activation may be implemented. Further, client device 105 may be configured to transmit and receive data and/or information over communication link 107 to and from service/data provider 110 by further connecting to a mobile communications network provided by a wireless service provider (not shown).

Client device 105 may be implemented as a portable (or mobile) electronic device such as a mobile phone, cell phone, smartphone, personal data assistant (PDA), a personal media player device, an application specific device, or a hybrid device that includes any of the above functions. Client device 105 may also be implemented as a personal computer including tablet, laptop computer, set-top box (i.e., gaming console), and non-laptop computer configurations, which may be connected to the aforementioned mobile communications network or, alternatively, to a wired network.

Further still, client device 105, regardless of its form factor, may have a user interface with which a user may interact using one or more of, e.g., a touch command (controlled by, e.g., finger, stylus, etc.), a voice command, physical gestures (controlled by, e.g., finger gestures, hand gestures, other bodily movements, etc.), or a cursor (controlled by, e.g., a mouse, trackball, gestures, etc.). To implement at least the interaction via touch command, client device 105 may include a multi-touch display having a touch sensing surface. To implement at least interaction by a voice command, client device 105 may include voice recognition capabilities built in, e.g., an operating system therefore. To implement at least the interaction via physical gestures, client device 105 may include, or be capable of being communicatively coupled to, a motion sensing input device or video capturing peripherals, e.g., built-in video camera, game console peripheral (e.g., Nintendo Wii®, Microsoft Kinect®, etc.).

The aforementioned wireless service provider for implementing communications for client device 105 may also be known as a mobile network carrier, wireless carrier, or even cellular company. Regardless of the alternate reference, the wireless service provider may provide services for mobile communications subscribers. Client device 105 may be configured to communicate with any of service/data provider 110 and/or third-party entity 115, who may similarly communicate with each other. Further, client device 105 may be configured to communicate with third-party entity 115 directly in a peer-to-peer networking environment, bypassing service/data provider 110.

Service/data provider 110 may be regarded as a cloud-based storage and dissemination platform owned and/or operated by a third-party service provider. Service/data provider 110 may include a framework of hardware, software, firmware, or any combination thereof, to which digital data and information may be stored or from which the digital data and information may be shared with subscribers to the hosted service. Thus, service/data provider 110 may be implemented as a telecommunications service provider and/or web-based storage and sharing service to which user of client device 105 registers prior to use. Such registration may include pre-configuration of user preferences or settings for data services including telephone communications; purchasing applications for client device 105; soliciting or contributing data, information, and/or media files from or to service/data provider 110; etc. More particularly, service/data provider 110 may relay data 111 from third-party entity 115 in the form of a client application or a security program by which customizable application functionality activation may be implemented on client device 105.

Data 111, as set forth above, may include a client application or security program for which an instance may be hosted or otherwise run on client device 105 to implement customizable application functionality activation. The application or security program may be revenue-based in the sense that revenue may be generated every time data 111 is purchased and/or updated for client device 105 or every time data 111 is actually run on client device 105. Of course, awareness of a product or service, as opposed to revenue, may motivate the implementation. Regardless, the aforementioned revenue or awareness may be generated for an owner, operator, or controlling entity of service/data provider 110 who is providing an owner, operator, or controlling entity of third-party entity 115 access to a user of client device 105 and, similarly, other subscribers to subscription services offered by service/data provider 110.

Servers 112a, 112b, . . . , and 112n may refer to servers hosted by or for service/data provider 110. More particularly, servers 112a, 112b, . . . , and 112n may be the access point at which data 111 may be received from third-party entity 115, via communication link 113, and may be accessed by or transmitted to client device 105, via communication link 107. Unless otherwise required, reference to servers 112a, 112b, . . . , and 112n may be substituted by a collective reference to “servers 112,” hereafter.

Third-party entity 115 may refer to an advertising entity, publisher, content provider, etc., that produces data 111 in the form of a client application or security program that facilitates customizable application functionality activation.

As produced or provided by third-party entity 115, data 111 may include, e.g., a customized functionality unlocking procedure. The customized functionality unlocking or activation procedure may include a derivation of an unlocking theme pre-installed in the OS of client device 105, with the derivation including, e.g., graphics representing one or more commercial products. For example, a customized functionality unlocking or activation procedure may include arranging movable components in the form of icons representing a particular product, company, etc., in a predetermined input sequence or predetermined placement sequence. The procedure may, in addition to or alternatively, include manipulating portions of the one or more icons representing the particular product, company, etc. For example, the procedure for a product-placement for a beverage company as third-party entity 115 may include stacking icons representing multiple products by the beverage company in a prearranged order, e.g., a pyramid. As an alternative example, the procedure for the same beverage company may include removing the cap from a graphical representation of a bottle of a beverage product made by the third-party entity beverage company. Of course, the foregoing examples are not intended to be limiting. Rather, multiple scenarios and permutations may be easily envisioned by placing commercial graphics into existing or new security schemes or processes for unlocking or activating at least partial functionality for one or more applications or features on client device 105.

Thus, with the customized functionality unlocking procedure included in data 111, third-party entity 115 may provide service/data provider 110 with an advertising-based revenue or awareness-generating scheme and provides itself with a veritable untapped advertising audience.

Communication links 107, 113, and 117 may include any mobile communications technology, e.g., GSM, CDMA, etc., depending upon the technologies supported by particular wireless service providers to whose services client device 105, service/data provider 110, and/or third-party entity 115 may be assigned or subscribed. Further, one or more of the aforementioned communication links 107, 113, and 117 may be implemented utilizing non-cellular technologies such as conventional analog AM or FM radio, Wi-Fi™, wireless local area network (WLAN or IEEE 802.11), WiMAX™ (Worldwide Interoperability for Microwave Access), Bluetooth™, hard-wired connections, e.g., cable, phone lines, and other analog and digital wireless voice and data transmission technologies.

Thus, in FIG. 1, configuration 100 provides an example, though not exclusive, environment by which customizable application functionality activation may be implemented.

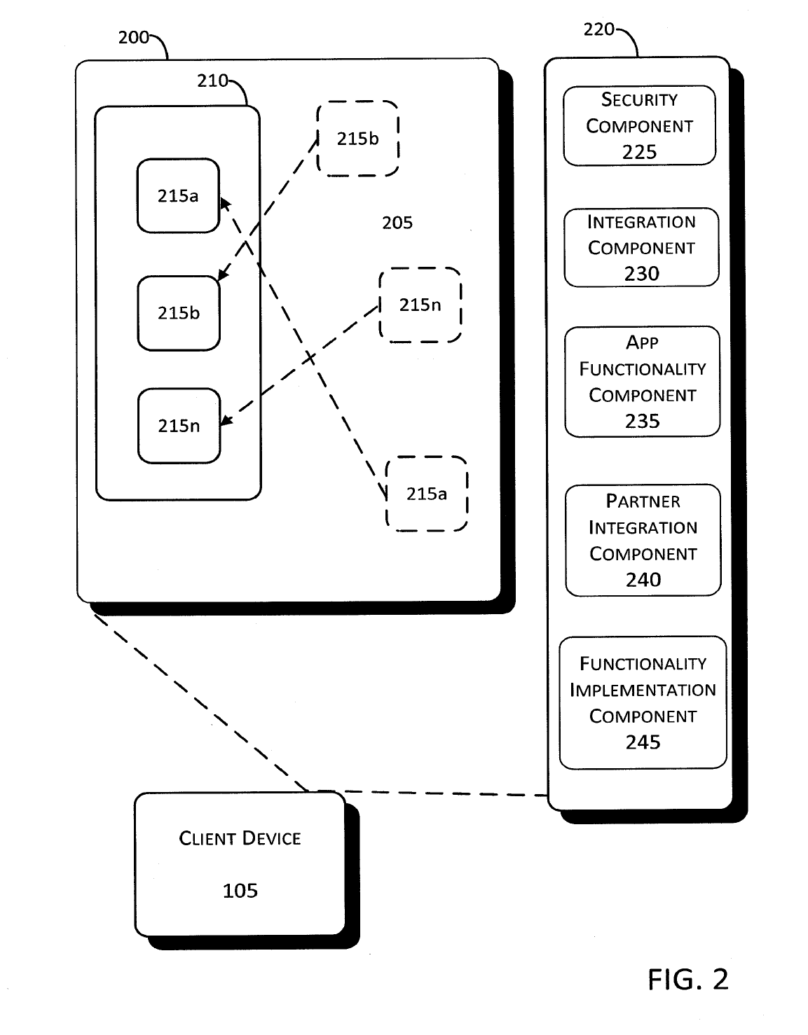

FIG. 2 shows an example configuration of a client device having a user interface and client application by which customizable application functionality activation may be implemented, arranged in accordance with at least some embodiments described herein.

Client device 105 may include a user interface (UI) 200 of various components or modules, e.g., implemented by one or more computer-readable media including but not limited to Application Specific Integrated Circuit (ASIC) or Customer Specific Integrated Circuit (CSIC). The various components or modules corresponding to application 200 may include, but are not limited to, display field 205; functionality initiation sequence field 210; and two or more movable components 215a, 215b, . . . , 215n.

Further, client device 105 may include an operating system (OS) configuration 220 of various components or modules, e.g., implemented by one or more computer-readable media including but not limited to ASIC or CSIC. The various components or modules corresponding to OS configuration 220 may include, but are not limited to, a security component 225, an integration component 230, an application functionality component 235, a partner integration component 240, and a functionality implementation component 245. Further, OS configuration 220 is not limited to such components or modules, as obvious modifications may be made by adding further components or modules or even eliminating at least one of the components or modules described here or even by having various components or modules assuming roles accorded to other components or modules in the following description.

As depicted in FIG. 2, UI 200 may refer to a graphical component of client device 105 and, more particularly, OS configuration 220. UI configuration 200 may be configured, designed, and/or programmed to solicit and receive user input for the implementation of customizable application functionality activation. As set forth above, the user input may be in the form of a touch command, a voice command, physical gestures, or a cursor, although these examples do not constitute a definitive sampling of input formats.

Display field 205 may refer to a graphical sub-field within UI 200 in which two or more movable components 215a, 215b, . . . , 215n may originally be displayed, in accordance with an initial state of the application or security program received at client device 105 as at least part of data 111.

Movable components 215a, 215b, . . . , 215n may refer to graphical components that are included in the application or security program received at client device 105 as at least part of data 111. Unless otherwise required, reference to movable components 215a, 215b, . . . , 215n may be substituted by a collective reference to “components 215,” hereafter. Further, as set forth above, in at least an initial state of the application or security program received at client device 105 as at least part of data 111, movable components 215a, 215b, . . . , 215n may be randomly placed in display field 205.

Functionality initiation sequence field 210 may refer to a graphical sub-field within UI 200, adjacent to or imposed on display field 205, that is configured, designed, and/or programmed to receive movable components 215a, 215b, . . . , 215n in a predetermined order to unlock or activate at least partial functionality for one or more applications or features on client device 105. Such features may be hardware, software, or even firmware components. As an example of unlocking or activating such features, even partially, movable components 215a, 215b, . . . , 215n may be moved from their initial random placement in display field 205, as depicted in FIG. 2, to the vertical order illustrated in functionality initiation sequence field 210. As another example, portions of movable components, replaced by icons representing a commercial product or service, may be manipulated as part of a game to be won or puzzle to be solved in order to unlock or activate at least partial functionality of one or more applications or features on client device 105. Accordingly, features including, but certainly not limited to, unlocking a screen on client device 105 to access data; unlocking a keypad (tactile or virtual) on UI 200; accessing a particular application hosted or run on client device 105; enabling telephone communication capabilities beyond emergency calls; etc, may be unlocked or activated on client device 105.

UI 200 may be configured, designed, and/or programmed as a software module that resides, at least in part, in a memory of client device 105 and which may be executed by one or more processors on client device 104.

As depicted in FIG. 2, OS configuration 220 may be hosted on or otherwise associated with client device 105. As discussed above, client device 105 may be communicatively coupled to service/data provider 110 and/or third party entity 115 via, e.g., at least a wireless local area network technology (WLAN), i.e., Wi-Fi. Thus, OS configuration 220 may be configured, designed, and/or programmed to facilitate interaction for client device 105 with, at least, any implementation of cloud-based service/data provider 110 and any implementation of third party entity 115 to implement customizable application functionality activation.

Security component 225 may refer to a component that is configured, designed, and/or programmed to receive input, presumably but not definitively input by a user of client device 105, to functionality initiation sequence field 210 to unlock at least partial functionality for one or more of the features of client device 105.

Integration component 230 may refer to a component that is configured, designed, and/or programmed to receive a customized sequence or algorithm to thereby revise at least a required input and/or placement sequence of movable components 215 and/or functionality initiation sequence field 210 needed to unlock at least partial functionality for one or more of the features of client device 105. Further, integration component 230 may be further or alternatively configured, designed, and/or programmed to customize the appearance of one or more of movable components 215.

The customized sequence or algorithm received by integration component 230 may be input by a user, programmer, designer, publisher, etc., to allow for enhanced security for data, applications, and other features hosted on client device 105. That is, a user or any of the aforementioned entities may change a default setting for the input and/or placement sequence of movable components 215 needed to unlock at least partial functionality for one or more of the applications or features on client device 105. Further, data 111 may require or strongly encourage that the input and/or placement sequence of movable components 215 be changed on a regular basis, based on time elapsed or number of activations. Regardless, a customized input and/or placement sequence of movable components 215 may be entered to integration component 230 as prompted using known techniques for an operating system on client device 105.

Application functionality component 235 may refer to a component that is configured, designed, and/or programmed to unlock at least partial functionality for a corresponding application or feature on client device 105 upon receiving notification of a properly received input and/or placement sequence of movable components 215 in functionality initiation sequence field 210 on UI 200. One instance of application functionality component 235 may be provided for multiple applications or resources on client device 105 and/or, alternatively one instance of application functionality component 235 may be provided for each application and resource on client device 105.

Partner integration component 240 may refer to a component that is configured, designed, and/or programmed to receive at least new or replacement product-placement graphics from third-party entity 115, directly or via service/data provider 110, for depiction as one or more of movable components 215. More generally, the received new or replacement product-placement graphics may include not only product-placement depictions as substitutes for one or more of movable components 215, but also may further include a product-themed background, product-themed background audio, and/or product-themed graphics that are not necessarily utilized in the unlocking of at least partial functionality for applications or features on client device 105.

Partner integration component 240, alternatively, may retrieve new or replacement product-placement graphics from a local storage on client device 105. Such stored replacement product-placement graphics may be received and stored on client device 105, e.g., at initialization of client device 105 or at as part of any reception of data 111 from service/data provider 110. Even further, the stored replacement product-placement graphics may be received, for local storage, at client device 105 directly from third-party entity 115 via a peer-to-peer connection, i.e., communication link 117.

Functionality implementation component 245 may refer to a component that is configured, designed, and/or programmed to combine, at least, the customized sequence or algorithm by integration component 230 and/or the new or replacement product-placement graphics from third-party entity 115 into a revised scheme or process for unlocking or activating at least partial functionality for one or more applications or features on client device 105, as part of a revenue or awareness generating model for an owner, operator, or controlling entity of service/data provider 110 and even, perhaps, and owner, operator, or controlling entity of third-party entity 115.

Functionality implementation component 245, alternatively, may be coupled to one or more of servers 112 at service/data provider 110, to receive one or more new and/or revised schemes or processes, in the form of one or more applications or programs included in data 11, to unlock or activate at least partial functionality for one or more applications or features on client device 105. That is, a revised scheme or process, as described above, may be received on client device 105 wholly or partially independent of input received by integration component 230 and/or partner integration component 240. In such scenario, the revised scheme or process may be included in an application received as part of data 111 from service/data provider 110.

Thus, FIG. 2 shows graphical and OS components of client device 105 that are utilized in generating revenue and/or awareness for at least one product by revising graphics utilized for unlocking, or activating, at least partial functionality for applications or features on a client device.

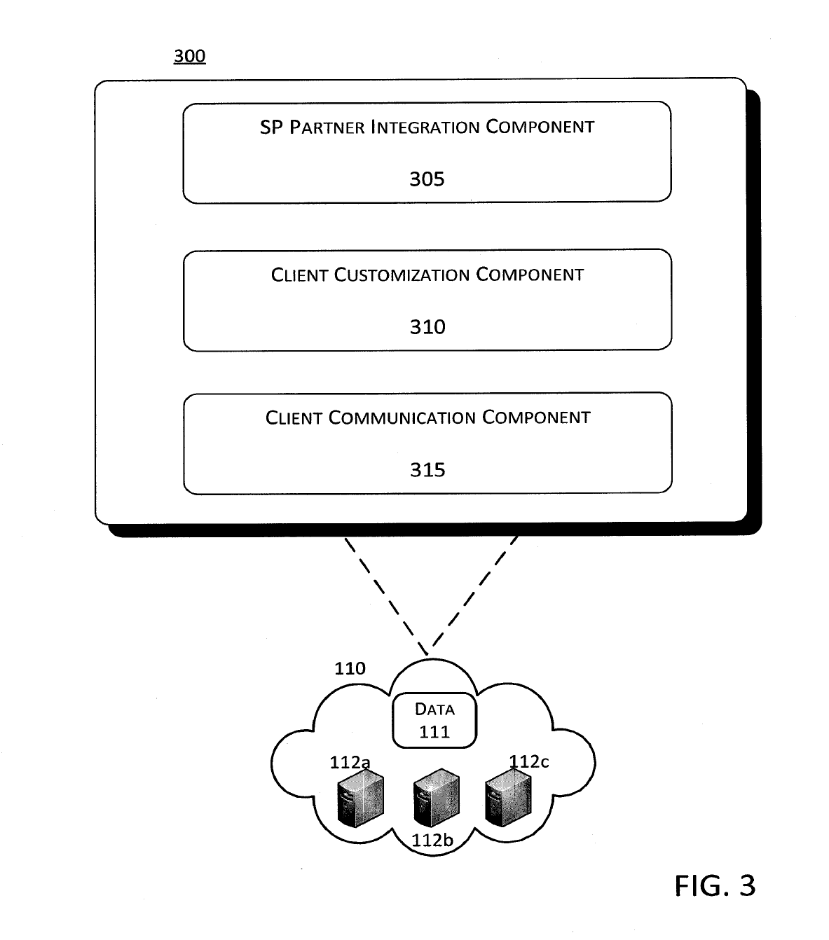

FIG. 3 shows an example configuration of a cloud-based service provider for implementing customizable application functionality activation, arranged in accordance with at least some embodiments described herein. Configuration 300 may include various components or modules, e.g., implemented by one or more computer-readable media including but not limited to ASIC or CSIC, hosted on one or more of servers 112. The various components or modules may include, at least, service provider (SP) partner integration component 305, client customization component 310, and client communication component 315. Further, configuration 300 is not limited to such components or modules, as obvious modifications may be made by adding further components or modules or even eliminating at least one of the components or modules described here or even by having various components or modules assuming roles accorded to other components or modules in the following description.

SP partner integration component 305 may refer to a component that is configured, designed, and/or programmed to receive at least new or replacement data 111 from third-party entity, via communication link 113. Data 111 may include an application or security program that, when received at client device 105, is utilized to unlock at least partial functionality for one or more of the features of client device 105. Further, data 111 includes product-placement graphics from third-party entity 115 for depiction as one or more of movable components 215 on UI 200 on client device 105. More generally, the received new or replacement product-placement graphics may include not only product-placement depictions substituting for one or more of movable components 215, but also may further include a product-themed background, product-themed background audio, and/or product-themed graphics that are not necessarily utilized in the unlocking of at least partial functionality for applications or features on client device 105.

SP partner integration component 305, in effect, may serve as a relay between third-party entity 115 and client device 105. Data 111 may include an application or security program as described immediately above. Alternatively, data 111 may include substitute or revised graphics for some or all of the application or security program utilized to unlock or activate at least partial functionality for one or more applications or features on client device 105. The substitute or revised graphics need not be utilized immediately, but rather may be stored locally on client device 105 for utilization at a subsequent time, e.g., dependent upon the passage of a predetermined amount of time or after a predetermined amount of usages of data 111 on client device 105.

Client customization component 310 may refer to a component that is configured, designed, and/or programmed to receive and store a customized sequence or algorithm for an application or security program included in data 111, in the event that the application or security program is hosted by service/data provider 110 with an instance thereof running on client device 105.

Client communication component 315 may refer to a component that is configured, designed, and/or programmed to facilitate all transmissions between service/data provider 110 and client device 105, via communication link 107.

Accordingly, FIG. 3 shows configuration 300 that facilitates the revenue generating model of providing product-placements and/or product-themed schemes or processes for unlocking or activating at least partial functionality for one or more application or features on client device 105.

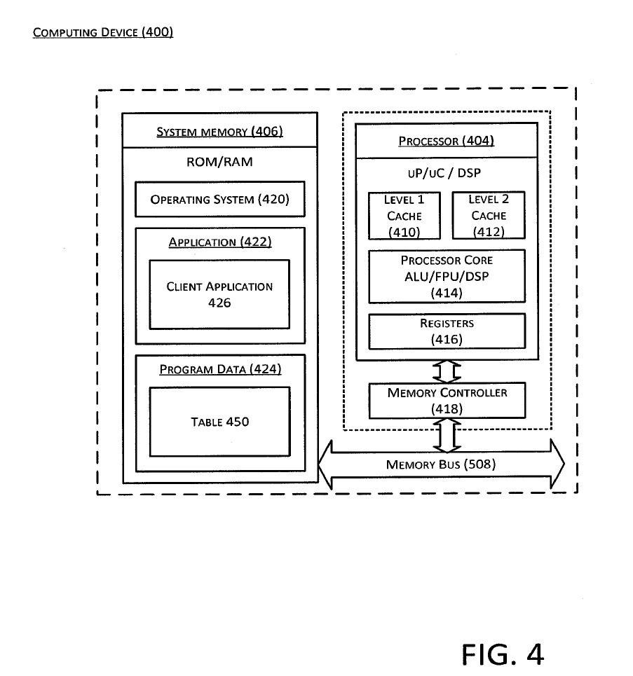

FIG. 4 shows a block diagram illustrating an example computing device 500 by which various example solutions described herein may be implemented, arranged in accordance with at least some embodiments described herein.

More particularly, FIG. 4 shows an illustrative computing embodiment, in which any of the processes and sub-processes described herein may be implemented as computer-readable instructions stored on a computer-readable medium. The computer-readable instructions may, for example, be executed by a processor of a mobile unit, a network element, and/or any other computing device, particularly as applicable to the applications and/or programs described above corresponding to the configuration 100 for customizable application functionality activation.

In a very basic configuration, a computing device 400 may typically include one or more processors 504 and a system memory 406. A memory bus 408 may be used for communicating between processor 404 and system memory 406.

Depending on the desired configuration, processor 404 may be of any type including but not limited to a microprocessor (μp), a microcontroller (μC), a digital signal processor (DSP), or any combination thereof. Processor 404 may include one or more levels of caching, such as a level one cache 410 and a level two cache 412, a processor core 414, and registers 416. The processor core 414 may include an arithmetic logic unit (ALU), a floating point unit (FPU), a digital signal processing core (DSP Core), or any combination thereof. A memory controller 418 may also be used with the processor 404; or in some implementations, memory controller 418 may be internal to processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424.

Application 422 may include the aforementioned application 200, e.g., client application 426, that may be arranged to perform the functions for masking phone numbers, which are described previously with respect to FIGS. 1-3. Program data 424 may include a table 450, which may be useful for implementing actuation of appropriate components or modules as described herein. For example, table 450 may include catalog information regarding data stored in a local cloud-based service and data center, information regarding other cloud-based service and data centers associated with a particular cloud-based storage service, etc.

System memory 406 is an example of computer storage media. Computer storage media may include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400, as described above, may be implemented as a portion of a small-form factor portable (or mobile) electronic device such as mobile client 102 or, alternatively, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein may be implemented, e.g., hardware, software, and/or firmware, and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes for system configuration 100 via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, e.g., as one or more programs running on one or more computer systems, as one or more programs running on one or more processors, e.g., as one or more programs running on one or more microprocessors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors, e.g., feedback for sensing position and/or velocity; control motors for moving and/or adjusting components and/or quantities. A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Lastly, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A device, comprising:
a user interface to receive a user's interactive input to a functionality activation sequence field;
a security component configured to receive a user's interactive input to the functionality activation sequence field on the user interface to unlock functionality for one or more device features;
an integration component configured to receive a customized algorithm for revising at least the appearance of the functionality activation sequence field on the user interface to unlock functionality for the one or more device features; and
a functionality implementation component configured to implement a customized functionality activation sequence on the user interface.

2. The device of claim 1, wherein the device is a smart phone.

3. The device of claim 1, wherein the functionality activation sequence includes a swipe.

4. The device of claim 1, wherein the functionality activation sequence includes an unlocking sequence.

5. The device of claim 1, wherein the one or more device features includes initiating outgoing phone calls.

6. The device of claim 1, wherein the one or more device features includes initiating applications hosted on the device.

7. The device of claim 1, wherein the security component is communicatively coupled to a server.

8. The device of claim 1, wherein the user's interactive input is touch-based.

9. The device of claim 1, wherein the integration component is configured to receive the customized algorithm from a service provider server.

10. The device of claim 1, wherein the integration component is configured to receive the customized algorithm from a third-party vender server.

11. The device of claim 10, wherein the revised appearance of the functionality activation sequence field on the user interface depicts an advertised product.

12. The device of claim 1, wherein the integration component is configured to receive the customized algorithm from a peer computing device.

13. The device of claim 1, wherein the integration component is further configured to revise required inputs for the functionality activation sequence.

14. A computer-readable medium storing computer-executable components, comprising:
a user interface to receive a user's interactive input to unlock device functionality in a functionality component;
an ad partner integration component to receive at least replacement product-placement graphics from a third-party entity and to further integrate the replacement product-placement graphics into the user interface;
a functionality implementation component configured to implement the functionality component using at least the replacement product-placement graphics.

15. The computer-readable medium of claim 14, wherein the computer-readable medium is hosted on a smart phone.

16. The computer-readable medium of claim 14, wherein the user's interactive input to unlock device functionality includes properly ordering graphic objects, and wherein further the ad partner integration component replaces the graphic objects with the replacement product-placement graphics.

17. The computer-readable medium of claim 16, wherein the ad partner integration component is further configured to change the proper ordering of the graphic objects based on the user's input.

18. The computer-readable medium of claim 14, wherein the ad partner integration component is communicatively coupled to a server hosted by a communication service provider.

19. The computer-readable medium of claim 14, wherein the ad partner integration component is communicatively coupled to a server hosted by a third-party advertising entity.

20. The computer-readable medium of claim 14, wherein the ad partner integration component is further configured to retrieve the replacement product-placement graphics from a local storage.

21. The computer-readable medium of claim 14, wherein the user interface includes product-placement graphics in the functionality component at activation.

22. The computer-readable medium of claim 14, wherein the device functionality includes outgoing phone calls.

23. The computer-readable medium of claim 14, wherein the device functionality includes activating device-hosted applications.

24. A system, comprising:
an advertising entity configured to:
transmit at least ad-based graphics for implementation on a user interface, and
transmit a revised security program;
a data service provider configured to:
receive the ad-based graphics from the advertising entity and to further store the ad-based graphics in corresponding servers, and
receive and transmit the revised security program; and
an electronic device configured to receive online services hosted by the data service provider and further configured to:
receive at least some of the ad-based graphics from the data service provider,
place the ad-based graphics into the user interface utilized for implementing applications run on the electronic device, and
receive, via the data service provider, the revised security program that utilizes the ad-based graphics for unlocking functionality of the electronic device to the data service provider.

25. (canceled)

26. The system of claim 25, wherein the revised security program is configured to be customized by a user of the electronic device.

27. A computer-readable medium storing computer-executable components, comprising:
at least two movable components that are initially randomly placed in a display field and that are configured to be movable by one or more user's command;
a functionality activation sequence field that is configured to receive the movable components in a predetermined order; and
a security component that is configured to unlock functionality for one or more device features upon receiving an indication from the functionality activation sequence indicating that the movable components have been received in the predetermined order.

28. The computer-readable medium according to claim 27, wherein the at least two movable components are icons representing an advertising entity.

29. The computer-readable medium according to claim 27, wherein the one or more user's commands include dragging at least one of the movable commands across a portion of the display field using a finger.

30. The computer-readable medium according to claim 27, wherein the one or more user's commands include dragging at least one of the movable commands across a portion of the display field using a hand-waving gesture.

31. The computer-readable medium according to claim 27, wherein the functionality activation sequence field is a portion of the display field.

32. The computer-readable medium according to claim 27, wherein the predetermined order includes at least a predetermined chronological sequence.

33. The computer-readable medium according to claim 27, wherein the predetermined order includes at least a predetermined placement pattern.

34. The computer-readable medium according to claim 27, wherein the one or more device features includes initiating outgoing phone calls.

35. The computer-readable medium according to claim 27, wherein the one or more device features includes initiating applications.
